(19) United States
(12) Patent Application Publication
(10) Pub. No.: US 2021/0403652 A1
(43) Pub. Date: Dec. 30, 2021

(54) WARPAGE-OPTIMIZED POLYMER POWDER

(71) Applicant: EOS GmbH Electro Optical Systems, Krailling (DE)

(72) Inventors: Andreas Hotter, Rosenheim (DE); Stoyan Frangov, Muenchen (DE); Marius Christ, Muenchen (DE)

(73) Assignee: EOS GmbH Electro Optical Systems, Krailling (DE)

(21) Appl. No.: 17/291,881

(22) PCT Filed: Nov. 7, 2019
(86) PCT No.: PCT/EP2019/080553

§ 371 Date: May 6, 2021

(30) Foreign Application Priority Data
Nov. 12, 2018 (DE) 10 2018 219 303.7

(51) Int. Cl. C08J 3/20; B33Y 70/00; B33Y 10/00; B29C 64/153; B29C 64/264; B33Y 80/00; C08L 77/02; C08L 77/06

(52) U.S. Cl. CPC C08J 3/203; B33Y 70/00; B33Y 10/00; B29C 64/153; B29K 2507/04; B33Y 80/00; C08L 77/02; C08L 77/06; B29C 64/264

(57) ABSTRACT

Plastic powder for use as building material for additively manufacturing a three-dimensional object by selectively solidifying the building material at the positions corresponding to the cross-section of the three-dimensional object in the respective layer, in particular by exposure to radiation, wherein the plastic powder comprises a mixture of polymer-based particles and particles of a particulate additive and wherein the particulate additive is selected such that the crystallization point of the mixture of the polymer-based particles and the particulate additive is substantially not increased compared to the crystallization point of a mixture of the polymer-based particles without the particulate additive.

The present invention relates to a plastic powder (i.e. polymer powder) for use in a method operating in a layer-by-layer manner for the manufacture of three-dimensional objects in which selective areas of a respective powder layer are melted and re-solidified. It is further an object of the present invention to provide a method for manufacturing a three-dimensional object using the plastic powder according to the invention as a building material, a three-dimensional object manufactured from the powder according to the invention, and a system for manufacturing three-dimensional objects according to the invention.

As is known, for example, from DE 44 10 046, a method for manufacturing a three-dimensional object can be carried out layer by layer by selective sintering using electromagnetic radiation with the use of an electromagnetic radiation source. In such a method, a three-dimensional object is manufactured layer by layer—according to the principle of “additive manufacturing”—by application of powder layers and bonding these layers with each other by selectively solidifying the powder at the positions corresponding to the cross-section of the object.

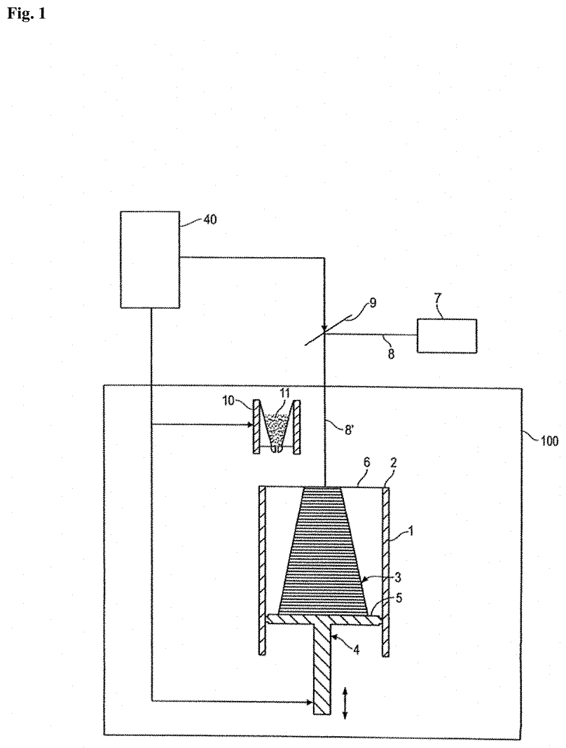

FIG. 1 shows by way of example a laser sintering device by means of which a method for the layer-by-layer manufacture of a three-dimensional object can be carried out. As can be seen from FIG. 1, the device has a container 1. This is open at the top and is confined at the bottom by a support 4 for carrying an object 3 to be formed. A working plane 6 is defined by the upper edge 2 of the container (or its side walls, respectively). The object is placed on the upper side of the support 4 and is formed from a plurality of layers of a pulverulent building material being solidifiable by means of electromagnetic radiation and extending parallel to the upper side of the support 4. Herein, the support is movable in the vertical direction, i.e. parallel to the side wall of the container 1, by means of a height adjustment device. This allows the position of the support 4 to be adjusted relative to the working plane 6.

Above the container 1 or the working plane 6, an application device 10 is provided for applying the powder material 11 to be solidified to the support surface 5 or a layer that has been solidified at last. Furthermore, an irradiation device in the form of a laser 7 is arranged above the working plane 6, which emits a directed light beam 8. This is deflected by a deflector 9, for example a rotating mirror, as a deflected beam 8′ in the direction of the working plane 6. A control unit 40 enables the control of the support 4, the application device 10 and the deflection device 9. The elements 1 to 6, 10 and 11 are arranged within the machine frame 100.

In the course of the manufacture of the three-dimensional object 3, the powder material 11 is applied layer by layer to the support 4 or to a previously solidified layer, respectively, and is solidified by the laser beam 8′ at the positions of each powder layer corresponding to the object. After each selective solidification of a layer, the support is lowered by the thickness of the next powder layer to be applied.

Compared to the system described above, there are many modifications of methods and devices for manufacturing a three-dimensional object (shaped body) by selective sintering using electromagnetic radiation that may also be used. For example, instead of a laser and/or a light beam, other systems might be used to selectively deliver electromagnetic radiation, such as mask exposure systems or the like.

As a building material, a powder with powder particles comprising a thermoplastic polymer material is often considered. The mechanical properties of the manufactured object can be influenced by a suitable selection of the polymer in the raw material. For example, polymers that lead to preferred mechanical material properties in the final object are described in DE 10 2008 024 281 A1 and DE 10 2008 024 288 A1. Likewise, it was described that the mechanical properties could be further improved by using fillers. For example, carbon fibres, glass fibres, Kevlar fibres, carbon nanotubes, or fillers that have a low aspect ratio (glass beads, aluminium grit, etc.) or mineral fillers such as titanium oxide could be incorporated into the polymer or copolymer-containing powder.

For the improvement of properties such as colour or the absorption of introduced energy for melting, additives, fillers, reinforcing fibres, and/or auxiliary materials can be admixed to polymer-based materials prior to processing. For the crystallisation of polymer-based materials from a melt, crystallisation nuclei must be present; the crystallisation rate results, inter alia, from the nucleation density (Gächter/Müller, Kunststoff-Additive, 3rd edition, page 893 et seqq.).

A major well-known disadvantage is that the addition of additives is usually accompanied by a reduction in the temperature window, poorer z-bonding of the layers, and greater distortion (warpage) of the three-dimensional objects of the methods operating according to the principle of “additive manufacturing”. Functional additives, fillers, reinforcing materials, and/or auxiliary materials usually act as additional nucleating agents, as a result of which the crystallisation speed and thus the analytically determined crystallisation temperature usually increase. The crystallisation temperature can be determined by the onset and extrapolated peak temperatures of a DSC measurement. An increase in the onset temperature of the crystallisation leads to a reduction in the SLS sintering window (Manfred Schmid, “Selektives Lasersintern (SLS) mit Kunststoffen”, 2015, pages 78 and 79) and to a significant increase in (construction) distortion of the laser-sintered three-dimensional objects due to earlier onset of shrinkage effects.

This disadvantage also becomes significant in particular if IR absorbers are added, as in the German patent application DE 10 2004 012 683 A1, for example in order to melt and/or fuse plastics with electromagnetic radiation of the wavelength in the near-infrared (NIR) range in a method operating according to the principle of additive manufacturing. Since most polymers do not absorb NIR radiation, the additive serves as an absorber of the NIR radiation, which absorbs the introduced energy at the wavelength and converts it into heat.

Therefore, it is an object of the present invention to provide a method and system for manufacturing a three-dimensional object by selectively solidifying the building material at the positions corresponding to the cross-section of the three-dimensional object in the respective layer by exposure to radiation, which at least partially overcomes the disadvantages described above. It is also a main objective of the invention to provide a powder for use as a building material in such an improved method, as well as a three-dimensional object manufactured by the advantageous method.

This objective is solved by a plastic powder according to claim 1, a manufacturing method according to claim 10, a three-dimensional object according to claim 11, and a system according to claim 12. Further embodiments of the invention are set forth in the dependent claims.

According to a first aspect of the present invention, the plastic powder comprises a mixture of polymer-based particles and a particulate additive, wherein the particulate additive is selected such that the crystallisation point of the mixture of the polymer-based particles and the particulate additive is substantially not increased compared to the crystallisation point of a mixture comprising the polymer-based particles without the particulate additive. Preferably, the particulate additive comprises a (preferably solid) particulate carbon material, preferably graphite and/or carbon black and in particular gas black. Preferably, the particulate additive consists of carbon black and/or graphite, in particular gas black. Gas black refers to carbon black that can be obtained as a residue from the combustion of natural gas. Compared to other industrial carbon black, gas black has a lower carbon content (<98 wt. %) and/or a narrower particle size distribution.

The particulate carbon material is selected such that the crystallisation point of the mixture of the polymer particles and the particulate additive is substantially not or practically not increased compared to the crystallisation point of a mixture of the polymer-based particles without the particulate additive. In particular, the property of the substantially not or practically not increased crystallisation point is satisfied if the increase is not more than 2.5° C., preferably not more than 2.0° C., and in certain embodiments not more than 1.5° C. When determining the increase of the crystallisation point, the fluctuation of the measurement method shall be taken into account, which in the case of DSC is between 0.5 and 1.0° C.

The powder according to the invention is intended to be used in particular as a building material for manufacturing a three-dimensional object by selective solidification of the building material at the positions corresponding to the cross-section of the three-dimensional object in the respective layer by exposure to radiation, in particular NIR radiation. The term “solidifying” is to be understood as at least partial melting with subsequent solidification or consolidation of the building material. In the context of solidification, the term “selective” refers to localised irradiation at positions of a continuous layer that are to be solidified, while positions of the layer that are not to be solidified are not irradiated. In contrast to such selective solidification is a technique in which no complete layer is spread, but the building material is spread only at points where solidification is desired. In this case, irradiation may also be applied to areas that are not to be solidified.

The term “three-dimensional object” is used here synonymously with the term “shaped body”. The term “polymer particles” is used herein synonymously for the term “polymer-based particles” and refers herein to particles comprising polymer described in more detail herein, preferably consisting thereof to the extent of at least 20% by weight, further preferably to the extent of at least 40% by weight, and in particular to the extent of at least 60% by weight. The remaining components may essentially comprise fillers.

The powder according to the invention has unexpected advantages in the additive manufacturing method as well as in the three-dimensional objects manufactured by it. Thus, the known negative influence of additives mixed into powders in the form of a dry mixture on the laser-sintering method can be significantly reduced. As a result, the negative influence on the component quality is also greatly reduced. Overall, therefore, there is a significant improvement with regard to the process window, the z-bonding of the layers, and/or the distortion of the components. This makes it possible to carry out a laser-sintering method with a light source in the NIR range without any adverse effects on the manufacturing method and/or the manufactured three-dimensional object.

A non-substantial increase in the crystallisation point means here that the increase in the crystallisation point is in particular not greater than 2.0° C. The crystallisation point can be determined by determining in a DSC measurement the temperature at which a melt of the mixture just starts to crystallise (T_{K onset}). The crystallisation point thus corresponds to T_{K onset}. The onset temperature can be determined by means of DSC (differential scanning calorimetry). The corresponding DSC measurements for determining the onset temperature are preferably carried out according to the ISO 11357 standard A suitable instrument is, for example, Mettler Toledo DSC 823.

The advantages and embodiments according to the invention are illustrated below.

In a preferred embodiment of the invention, the particulate additive has a mean primary particle diameter in the nm range. The term “nm range” refers to a size range from 1 nm to 999 nm. Preferably, the particulate additive has a mean primary particle diameter of at most 500 nm, more preferably at most 250 nm, more preferably at most 100 nm, and in particular at most 60 nm. In this way, the undesirable increase in the crystallisation point of the mixture of the polymer-based particles and the particulate additive in comparison with the crystallisation point of a mixture of the polymer-based particles without the particulate additive can be minimised or avoided.

The term “primary particle diameter”, as distinguished from the diameter of an agglomerate or secondary particles, refers to the particle size of an originary, non-agglomerated particle. This means that an agglomerate consists of many primary particles, which represent the smallest, non-divisible unit of the agglomerate. Starting from agglomerates, primary particles may be obtained by treating a sample in an ultrasonic bath. Preferably, the primary particle diameter refers to the mean diameter. For the purposes of the present invention, the primary particle diameter can be determined according to ASTM D3849, in particular via morphological characterisation using transmission electron microscopy (TEM) according to ASTM D3849.

For the purpose of determining the primary particle diameter, for example a LEO 912 Omega: 120 kV TEM instrument with a Proscan Slow Scan CCD 1024×1024 pixel camera and a 460 mesh copper grid with carbon film is suitable. Image analysis may be performed using Olympus Soft Imaging Solutions “analySIS”. For sample preparation, 8 mg of a sample may be dispersed in one millilitre of isopropanol for 5 min in an ultrasonic bath. Therefrom, a few drops may be taken and dispersed again in one millilitre of isopropanol for 5 min in an ultrasonic bath. Subsequently, a drop of the solution may be dropped onto a copper grid. The microscopic examination may be performed at different magnifications. Preferably, the examination may be performed at a microscope magnification of 2000 times (including post-magnification of the camera, the magnification is 40000 times). Optionally, a calibration check may be performed using a line grating grid with defined line spacing and/or a qualification test based on the TEM surface.

In a preferred embodiment of the invention, the particulate additive comprises, or consists of, a particulate NIR absorber. This applies, for example, to solid particulate carbon material, in particular carbon black and/or graphite. The term “NIR absorber” is used here to denote a substance or mixture of substances that at least partially absorbs near-infrared (NIR) radiation. For the sake of readability, the following statements refer to a substance as NIR absorber. The same applies if a mixture of substances is used as NIR absorber. According to the invention, the NIR absorber may comprise carbon black, wherein it is preferred that the NIR absorber is carbon black and further NIR absorbers are not present or are present only to a minor extent. The term “to a small extent” means that the ratio of the absorption of carbon black to the absorption of the further NIR absorbers in at least a part of the NIR range is at least 2 or 3, preferably at least 4 or 5, further preferably at least 6 or 7, and more preferably at least 8 or 9 or at least 10. The NIR absorber preferably exhibits absorption at at least one of the wavelengths 980±10 nm and/or 940±10 nm and/or 810±10 nm and/or 640±10 nm.

Within the scope of the present invention, further suitable additives may in principle be added to the dry mixture in order to impart advantageous properties to the plastic powder or to the three-dimensional object manufactured therefrom, or in order to make use of certain advantageous properties of such additives in the manufacturing method. However, in order to make use of the advantages of the present invention as much as possible, it is preferred that the dry mixture comprises at least one or more additives which reflect (in the proportion by weight and particle size used) at most 70%, 60% or 50%, preferably at most 40%, 30% or 20%, and in particular at most 15%, 10% or 5% of the NIR radiation. This ensures that the NIR radiation in the plastic powder is available to the NIR absorber for heat generation and is not reflected unused. Since laser diodes deliver significantly less energy than standard lasers (such as, e.g. CO₂ lasers), the powder can only be processed in this way at all and the energy saving may be used as an advantage.

From the context described above, it is clear that in one embodiment of the invention, the plastic powder may well comprise reflective particles having a surface that at least partially reflects the NIR radiation. By this measure, on the one hand, the advantages associated with certain substances reflecting in the IR range and, at the same time, the effects associated with the present invention can be exploited.

For example, titanium dioxide, known as a white pigment, acts as such a reflective particle. The use of titanium dioxide has unexpected advantages, particularly in the context of the present invention. This will be described below.

As described at the beginning, the present invention intends the use of NIR absorbers to increase absorption in the NIR wavelength range (e.g. <1 μm). The inventors found that carbon black has a very high absorption capacity and the ability to efficiently convert the absorbed energy into heat. In the case of a universally applicable material, the amount of carbon black should be as small as possible so that the brightest possible three-dimensional object may be manufactured. This makes the component more suitable for subsequent colouring, especially with light colours.

In the case of plastics, natural products with brownish off-white are called natural-coloured. When using natural-coloured plastics in a mixture with carbon black, the inventors noticed that the components made from them had an inhomogeneous colour impression. The components appear “stained”.

Surprisingly, it was found that components with a much more homogeneous colour impression could be produced if TiO₂ was mixed into the natural-coloured plastic beforehand. Thus, by adding titanium dioxide, components with a homogeneous colour may be obtained even when using small amounts of carbon black. Accordingly, the reflective particles preferably comprise TiO₂. Preferably, the reflective particles are substantially formed of TiO₂.

Preferably, the weight percentage of the reflection particles in the total weight of the plastic powder is between 0.5% and 15.0%, preferably at least 0.5% and/or at most 5%, in particular at least 0.5% and/or at most 2%.

In a preferred embodiment of the invention, the plastic powder is in the form of a preferably homogeneous dry mixture of the polymer-based particles with the particulate additive. In the preferred embodiment, the dry mixture is a mixture of the polymer-based particles and the particulate additive, i.e. the particles of the additive have not been incorporated into the polymer-based particles, for example via a polymer melt or by joint precipitation from a solution or in any other way. The term “dry mixture” is synonymous with the term “dry blend” and, according to the invention, means a mixture of the polymer-based particles and particles of the particulate additive. Optionally, the dry mixture may additionally comprise one or more further substances, which may optionally be mixed in the dry-blend process and/or incorporated completely or at least partially into the polymer particles.

In particular, for the purposes of the present invention, a distribution is considered “homogeneous” if in a plurality (e.g. 2, 3, 4, 5, 6, etc.) of random samples the smallest NIR absorber concentration deviates from the largest NIR absorber concentration by less than 30%, preferably less than 20%, more preferably less than 10%. Preferably, the samples are taken from a mixture of at least 1 g, more preferably at least 5 g. This preferably avoids a spatially different absorption of the NIR radiation. The process stability is increased and the result is a three-dimensional object with improved mechanical properties.

The powder according to the invention is obtainable by mixing the polymer-based particles with the particles of the NIR absorber and, if necessary, further additives in a mixing step in the appropriate mixing ratio, so that the specified proportion by weight is adjusted. The mixing procedure is expediently carried out in a one-step process by:

(i) providing the polymer-based particles and the particles of the NIR absorber; and
(ii) dry mixing of at least the polymer-based particles and the particles of the NIR absorber.

For this purpose, for example, a container mixer from the company Mixaco CM150-D with standard blade design—1 bottom scraper and 1 dispersion blade (blade with a diameter of 400 mm)—is suitable, with which a two-stage mixing with 2 min at 516 rpm and 4 min at 1000 rpm may be carried out.

The mixing procedure may, however, also be carried out with several mixing steps (multi-stage process):

(i) providing a first dry mixture (so-called master batch) by dry mixing of at least polymer-based particles and carbon black particles with a first proportion of carbon black particles,
(ii) addition of further polymer-based particles to the first dry mixture to obtain a second dry mixture with a second proportion of carbon black particles which is lower than the first proportion,
(iii) optionally further separate addition steps of in each case further polymer-based particles to the second and optionally further dry mixture(s) to obtain in each case increasingly further reduced proportions of carbon black particles. Optionally, the dry mixture may be sieved at least once in at least one of the steps (i) and (ii) and the optional step (iii) and/or after completion of the addition steps, preferably through a sieve of mesh size 125 μm. The mixing process in one stage or in several stages is carried out with the proviso that, after completion of the addition step (ii) or addition steps (iii), the proportion by weight of carbon black in the total weight of polymer-based particles and carbon black particles is in the predefined range.

Surprisingly, it has been found that the homogeneity is better with the single-stage process than with the multi-stage process. Accordingly, the single-stage process is the preferred embodiment among the two alternatives. The invention thus turns away from providing the plastic powder by means of a master batch process and rather towards providing the entire amount of plastic powder in a single process step, i.e. in a single batch process. The advantages of the single batch process include, in addition to a more homogeneous distribution of the NIR absorber in the powder, in particular a simpler and more cost-efficient process, since only one step has to be carried out.

In a preferred embodiment of the invention, the particulate additive is gas black. Preferably, the gas black has an average primary particle diameter in the range from 1 to 50 nm, preferably an average primary particle diameter of at least 5 nm and/or at most 47 nm, more preferably of at least 10 nm and/or at most 30 nm, in particular of at least 15 nm and/or at most 25 nm.

Advantageously, such a selection of the average primary particle diameter improves the process stability and/or moulding quality. Furthermore, improvements in the fluidisability and/or the coating quality as well as a constant coating behaviour and/or a sufficiently large process window can be achieved. The process window is defined as the temperature range between the crystallisation temperature (TC) and the melting temperature (TM). Surprisingly, it was found in the context of the invention that the mentioned improvements are related to the average primary particle diameter, regardless of the extent or degree to which the original primary particles were de-agglomerated when mixed with the polymer-based particles.

Coating quality is defined as a uniformly dense coating of the surface without areas with visibly lower bulk density, regardless of whether there is powder or a previously melted building material under the coated powder layer. Constant coating behaviour refers to stable coating behaviour over the duration of an entire construction job, possibly over several hours. A build job refers to the building of a job, wherein a job is the compilation of positioned and parameterised three-dimensional objects in the software.

In a preferred embodiment of the invention, the weight percentage of the particulate additive of the total weight of polymer-based particles and particulate additive is 0.01% to 5%, preferably at least 0.02% and/or at most 2%, further preferably at most 1%, even further preferably at most 0.45%.

In a preferred embodiment of the invention, the polymer of the polymer-based particles is a thermoplastic and/or semi-crystalline polymer.

In principle, the present invention is not limited to specific polymer-based plastics. Suitable polymer bases may be selected from the group consisting of homopolymers, copolymers, and polyblends (also known as polymer blends). A polyblend (also known as a “polymer blend”) is understood to be a mixture of two or more different polymers. A polyblend may be a single-phase polyblend (homogeneous polyblend) or a multi-phase polyblend (heterogeneous polyblend). In the case of a multi-phase polyblend, several glass transitions are typically observed by means of differential scanning calorimetry. Furthermore, in a multiphase polyblend, multiple melting peaks corresponding to the melting points of the individual phases can be observed by means of differential scanning calorimetry.

The polymer may be selected from polyaryletherketone (PAEK), polyarylethersulfone (PAES), polyamides, polyesters, polyethers, polylactides (PLA), polyolefins, polystyrenes, polyphenylene sulfides, polyvinylidene fluorides, polyphenylene oxides, polyimides, polyetherimides, polycarbonates, and copolymers including at least one of the foregoing polymers or monomer units thereof, and polymer blends of one or more of the foregoing polymers or copolymers thereof, wherein the selection is not limited to the above polymers and copolymers and polymer blends thereof. The term “polymers” may also include oligomers having a cyclic or ring-shaped molecular structure. An example of such an oligomer is CBT (cyclic butylene terephthalate) for the preparation of PBT (polybutylene terephthalate).

Suitable PAEK polymers and copolymers, for example, are selected from the group consisting of polyether ether ketone (PEEK), polyether ketone ketone (PEKK), polyether ketone (PEK), polyether ether ketone ketone (PEEKK), polyether ketone ether ketone ketone (PEKEKK), polyarylether ether ether ketone (PEEEK), and copolymers including at least one of the aforementioned polymers.

Suitable polyamide polymers or copolymers may be selected from the group consisting of polyamide 6/6T, polyamide elastomers such as polyether block amides such as PEBAX-based materials, polyamide 6, polyamide 66, polyamide 11, polyamide 12, polyamide 612, polyamide 610, polyamide 1010, polyamide 1012, polyamide1212, polyamide PA6T/66, PA4T/46, and copolymers including at least one of the aforementioned polymers. Suitable polyester polymers or copolymers may be selected from the group consisting of polyalkylene terephthalates (e.g. PET, PBT) and copolymers thereof.

Suitable polyolefin polymers or copolymers may be selected from the group consisting of polyethylene and polypropylene. Suitable polystyrene polymers or copolymers may be selected from the group consisting of syndiotactic and isotactic polystyrenes. Suitable polyimide polymers or copolymers may be selected from the group consisting of polyarylamide, polybismaleinimide and in particular polyetherimide.

In a preferred embodiment of the invention, the polymer particles comprise as polymer material at least one polymer selected from at least one polyaryletherketone (PAEK), polyarylethersulfone (PAES), polyamide, polyester, polyether, polylactide, polyolefin, polystyrene, polyphenylene sulphide, polyvinylidene fluoride, polyphenylene oxide, polyimide, polyetherimide, polycarbonate, preferably from polyamide, further preferably from polyamide 12, polyamide 11, and/or polyamide 1012, and/or from at least one copolymer which includes at least one of the preceding polymers or their monomer units, and/or from at least one polymer blend comprising at least one of the mentioned polymers or copolymers. Preferably, the polymer is polyamide, further preferably polyamide 12, polyamide 11, and/or polyamide 1012.

In one embodiment of the invention, the polymer-based particles comprise as polymer material polymers or copolymers or blends of PAEK, polyamide or polyetherimide, wherein the PAEK is preferably PEEK, PEKK, PEK, PEEKK, PEKEKK, and/or PEEEK and the preferred polyamide is polyamide 12 and/or polyamide 11. Furthermore, the three-dimensional objects made of these polymeric materials meet the high demands made with respect to mechanical stress.

The present invention is also suitable for use with polyblends.

If the polymer has the property of not absorbing or only slightly absorbing electromagnetic radiation in at least part of the NIR range, the particulate additive preferably comprises or consists of a particulate IR absorber. As mentioned at the outset, this applies to most of the polymers. By the term “to a small extent” it is meant that the absorption of the polymer-based particulate present in excess is significantly smaller than the absorption of the NIR absorber.

For example, the ratio of the absorption of the NIR absorber to the absorption of the polymer-based particles in at least part of the NIR range (e.g. at one or more of the wavelengths (980±7) nm and/or (940±7) nm and/or (810±7) nm and/or (640±7) nm) is at least 2 or 3, preferably at least 4 or 5, more preferably at least 6 or 7, and in particular at least 8 or 9 or at least 10.

With regard to the particle size of the polymer-based particles, there are no restrictions beyond those customary in the field of laser sintering. Suitable average particle sizes d₅₀ are at least 10 μm, preferably at least 20 μm, particularly preferably at least 30 μm and/or at most 150 μm, preferably at most 100 μm or 90 μm, particularly preferably at most 80 μm, in particular at least 40 and/or at most 70 μm.

A further aspect of the present invention is a method for preparing the specific plastic powder according to the invention. In particular, the powder is intended for use in a method for the additive manufacturing of a three-dimensional object, in particular by selective solidification of a pulverulent building material at the positions corresponding to the cross-section of the three-dimensional object in the respective layer, in particular by the action of radiation. According to the invention, the method comprises at least the following steps:

(i) providing the polymer-based particles,
(ii) providing the particles of particulate additive, and
(iii) dry mixing at least the polymer-based particles and the particles of particulate additive.

Optionally, other additives such as TiO₂ may be mixed together with the polymer-based particles and the particles of particulate additive.

Optionally, after step (iii), packaging of the polymer powder may be carried out, preferably with exclusion of moisture.

In a preferred embodiment, the polymer-based particles are mixed with the particles of the particulate additive and optionally further additives in a one-step process in the desired mixing ratio, so that the specified weight percentage is adjusted. However, the mixing process may also be carried out as described above with several mixing steps (multi-stage process). As also explained above, the homogeneity is better in the single-stage process than in the multi-stage process.

In an advantageous embodiment, the mixture of polymer and particulate additive is homogeneous. Particularly good homogeneity is achieved by the one-step mixing process disclosed here.

Another aspect of the present invention is a shaped body or three-dimensional object manufactured by selectively solidifying a pulverulent building material at the locations corresponding to the cross-section of the three-dimensional object in the respective layer by the exposure to radiation, preferably by the exposure to NIR radiation. NIR radiation is not absolutely necessary, but preferred. In principle, the powder may also be processed by other layered manufacturing methods and unexpectedly offers the same advantages here.

Preferably, the three-dimensional object has at least one or both of the following features:

(a) microscopically observed crystalline regions in the form of spherulites with a spherulite size of at least 20 μm,
(b) a manufacturing distortion Δ(h_{centre}−h_{left})+Δ(h_{centre}−h_{right}) of <0.5 mm, preferably ≤0.25 mm, more preferably ≤0.2 mm.

To determine the distortion, a cuboid (e.g. with the dimensions 250 mm×6 mm×21 mm) may be built. As a measure of the manufacturing distortion (distortion during the manufacturing process), the difference in the height of the cuboid between the measuring points at the edge and a measuring point in the middle (in the example: x=125 mm) of the cuboid is given as a percentage in relation to the actual height of the cuboid in the middle, wherein the height of the cuboid in the middle is usually larger than at the edges.

As a measure of the cooling distortion (distortion after the manufacturing process, not resulting in missing material in contrast to the manufacturing distortion), the curvature of the bottom side of the three-dimensional object in the middle of the three-dimensional object (in the example: x=125 mm) is indicated, wherein the shape of the curved bottom side is mathematically approximated with a parabola.

The following applies: f(x)=ax², with a=0 for a non-distorted component.

The curvature of a graph is defined as κ(x)=((∂²f(x))/∂x²)/[(1+(∂f(x)/∂x)\hat{ }2)]\hat{ }(3/2).

Thus, at the centre of the component corresponding to the vertex of the parabola, κ(0)=2a.

In a preferred embodiment, the plastic powder according to the invention preferably served as the building material.

The plastic powder according to the invention is suitable for conventional laser sintering methods using a CO₂ laser as well as for methods based on short-wave radiation, e.g. NIR radiation, as well as for other additive manufacturing methods such as Multi Jet Fusion from HP. Surprisingly, the addition of particles of the particulate additive offers the same advantages in both methods.

By using the plastic powder according to the invention as a building material, the following effects result in addition to the aforementioned advantages, which also represent a preferred embodiment of the invention. Accordingly, in a preferred embodiment, the three-dimensional object has at least one and preferably a combination of two or multiple, more preferably all of the properties defined below:
(i) A tensile strength of at least 40 MPa, preferably at least 48 MPa;
(ii) a Young's modulus of at least 1600 MPa; preferably at least 1700 MPa;
(iii) an elongation at break of at least 2.5%; preferably at least 3.0%

Tensile strength, Young's modulus, and elongation at break were determined in accordance with EN ISO 527, using test specimens of type 1BB. The conditioning state has relevant influences on the measurement results of the mechanical properties such as tensile strength, Young's modulus, and elongation at break. The mechanical properties of the test specimens were determined in dry condition, wherein the test took place at most 3 hours after unpacking of the specimens. According to ISO 291, a temperature of (23±2) ° C. and a relative humidity of (50±10) % is used as preferred test climate for the determination of the mechanical properties. This test climate should be maintained when determining the mechanical properties. According to EN ISO 527-1, the test speeds should be agreed between the interested parties. A test speed of 50 mm/s was used.

In order to make the process more economical and environmentally friendly, part of the unsolidified building material left over from a previous manufacturing cycle (“used powder”) may be reused in a subsequent cycle. For this purpose, the used powder is mixed with fresh powder mixture (“virgin powder”) in a predetermined ratio. In a preferred embodiment, the building material thus comprises a proportion of used powder, which has previously remained as unsolidified building material during the manufacture of a three-dimensional object, and a proportion of virgin powder, which has not previously been used in the manufacture of an object. Preferably, the proportion of virgin powder is at most 70% by weight, in particular at most 60%, 50%, or even 40% by weight.

Another aspect of the present invention provides a system for manufacturing three-dimensional objects by selectively solidifying the powdered building material according to the invention at the locations corresponding to the cross-section of the three-dimensional object in the respective layer by exposure to radiation, preferably NIR radiation. According to the invention, the system comprises at least one radiation source designed to emit electromagnetic radiation, in particular specifically in a wavelength or wavelength range located in the NIR, a process chamber designed as an open container with a container wall, a support arranged in the process chamber, wherein the process chamber and the support are movable relative to each other in the vertical direction, a storage container, and a recoater movable in the horizontal direction. The storage container is at least partially filled with the plastic powder of the invention as building material.

In a preferred embodiment of the invention, the electromagnetic radiation is specifically emitted in the NIR range within a window (λ2−λ1) of not more than 50 nm (λ2−λ1≤50 nm), preferably not more than 40 nm, further preferably not more than 30 nm and in particular not more than 20 nm. This makes it possible for the plastic powder according to the invention to comprise further substances which would interfere in a first sub-range of the NIR range due to their absorption or reflection capability. By selecting a relatively narrow wave range outside the first sub-range, the interfering influence may be reduced or avoided.

In a preferred embodiment, the radiation source is designed to emit electromagnetic radiation specifically in a wavelength or wavelength range located in the NIR. In a preferred embodiment of the invention, the radiation source emits electromagnetic radiation specifically at one or more wavelengths in the range 500 to 1500 nm, in particular at one or more of the following wavelengths: (980±10) nm and/or (940±10) nm and/or (810±10) nm and/or (640±10) nm. Preferably, the radiation source emits at (980±10) nm and/or (940±10) nm.

In a preferred embodiment of the invention, the radiation source comprises at least one laser, preferably one or more laser diodes. The laser diodes may be arranged in a row or staggered. It is also possible to arrange the laser diodes in a 2-dimensional array. It may be an edge emitter. Preferably it is a surface emitter (VCSEL or Philips-VCSEL). High construction speeds may be achieved by line exposure. In addition, the use of laser diodes enables high efficiency and reduces energy costs.

For melting the polymer powder according to the invention layer by layer, suitable process or system parameters are selected. In addition to the amount of the NIR absorber to be adjusted, the layer thickness, the laser power and the exposure speed as well as the wavelength of the laser are purposefully selected.

Suitable laser diodes usually operate with a power of between 0.1 and 500 watts, preferably at least 1.0 watt and/or at most 100 watts. The focus of the laser beam may have a radius of between 0.05 mm and 1 mm, preferably of at least 0.1 mm and/or at most 0.4 mm. The exposure speed, i.e. the speed of the laser focus relative to the build plane, is typically between 10 mm/s and 10000 mm/s, preferably at least 300 mm/s and/or at most 5000 mm/s.

In the context of the present invention, the terms “comprising” or “containing” and grammatical variations thereof have the following meanings: In one embodiment, further elements may be included in addition to those mentioned. In another embodiment, substantially only the mentioned elements are included. In other words, in addition to their conventional meaning, the terms may in a particular embodiment be synonymous with the term “consisting essentially of” or “consisting of”.

FIG. 1 shows by way of example a conventional laser sintering device for the layer-by-layer manufacture of a three-dimensional object.

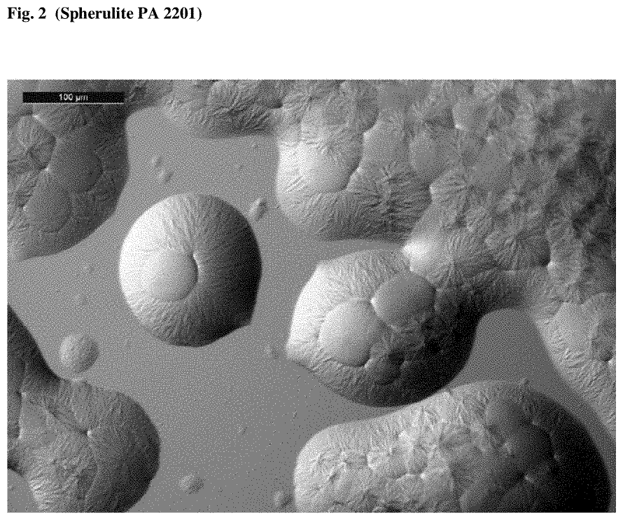

FIG. 2 shows a magnified image of a cooled melt of PA 12. Large spherulites are visible.

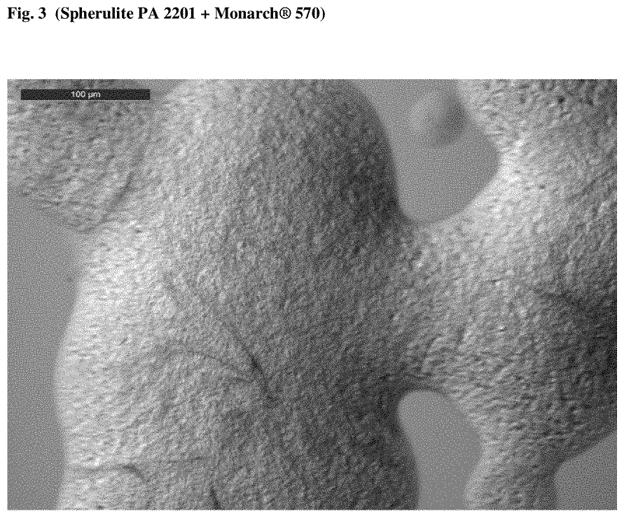

FIG. 3 shows a magnified image of a cooled melt of a mixture of PA 12 and industrial carbon black using the example of Monarch® 570. Many small spherulites are visible.

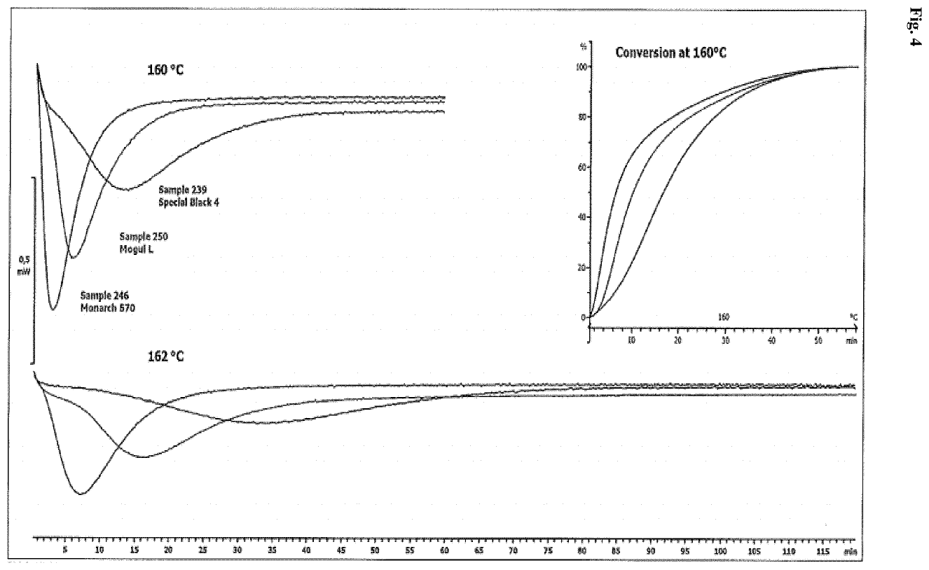

FIG. 4 shows DSC iso-curves and conversions of mixtures of polymer particles and different types of carbon black.

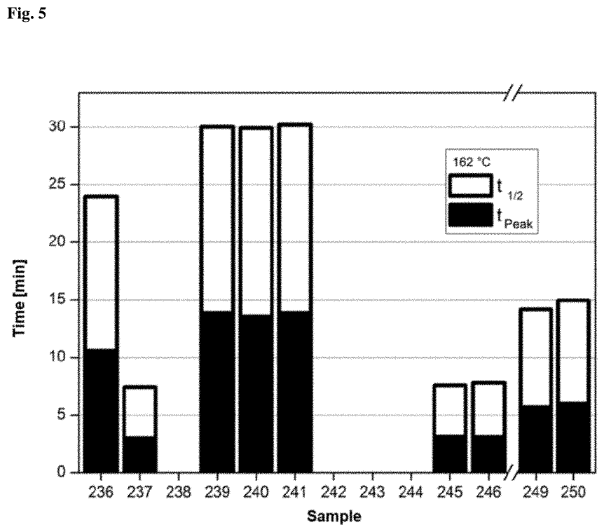

FIG. 5 shows values for tₚₑₐₖ [min] and t_{1/2} [min] and α [%] conversion determined from the DSC iso-curves and conversions of FIG. 4.

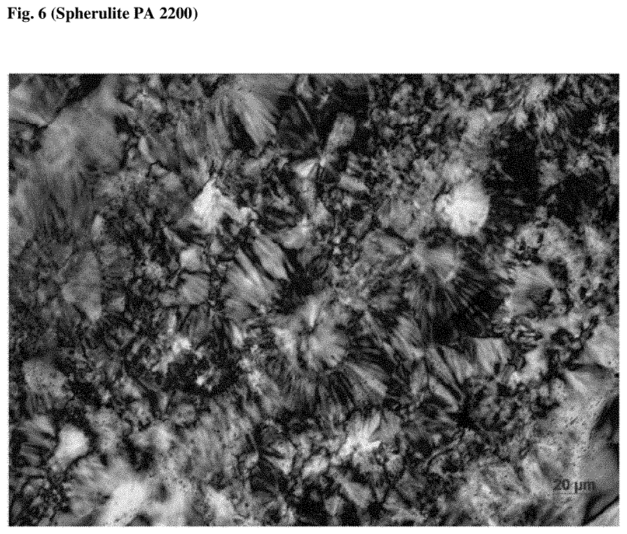

FIG. 6 shows a magnified image of a cooled melt of PA 12. Large spherulites are visible.

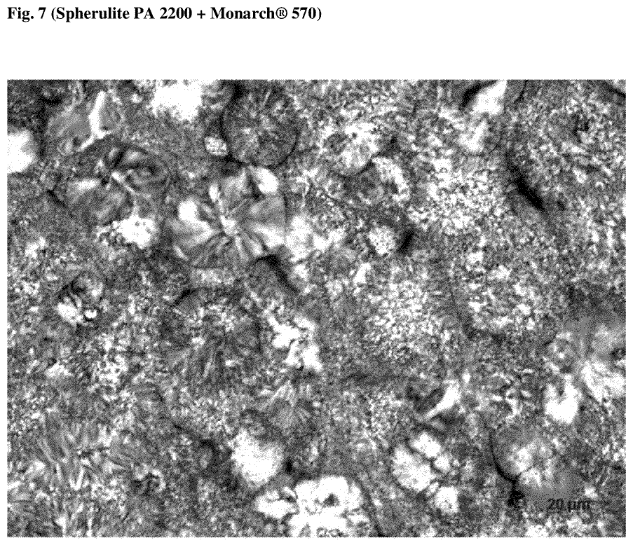

FIG. 7 shows a magnified image of a cooled melt of a mixture of PA 12 and industrial carbon black using Monarch® 570 as an example. Many small spherulites are visible.

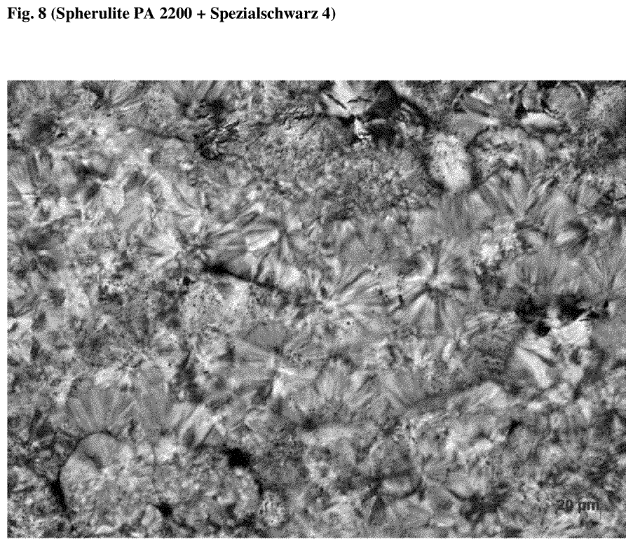

FIG. 8 shows an enlarged image of a cooled melt of a mixture of PA 12 and gas black using the example of Spezialschwarz 4. The size of the spherulites is comparable to that of the melt in FIGS. 2 and 7.

The following examples are for illustrative purposes and are not to be understood as restrictive. They define further preferred embodiments of the invention.

### EXAMPLES

### Embodiment 1

Mixtures of polymer-based particles and different types of particulate additives were prepared. Various types of particulate carbon material were tested as particulate additives, wherein corresponding tests can equally be carried out with other particulate additives. The polymer-based particles were identical in all blends and, as a representative example, were made of PA 2201. They exhibited high sphericity and had a d50 value of 50-62 μm. PA 2201 was used as an example for polymer-based particles based on PA12.

Various commercial products containing industrial carbon black or graphite were used as types of particulate carbon material. The following types were used:
Gas black: Spezialschwarz 4, Spezialschwarz 5, Spezialschwarz 6.
Lamp black: Flammrufβ 101, Monarch 570, Mogul L, Printex 200, Printex G, Printex XE-2B; Ensaco 150 P, Arosperse 15
Graphite: Timrex SFG 6 Graphite

The different manufacturing methods result in significantly different particle size distributions (PSD). Lamp black has a wide PSD and gas black a narrow PSD. Gas blacks usually have oxidised surfaces.

The mixtures were homogeneously mixed by means of a container mixer of the company Mixaco CM150-D with standard blade design: 1 bottom scraper and 1 dispersion blade (blade with a diameter of 400 mm) with a two-stage mixing with 2 min at 516 rpm and 4 min at 1000 rpm and then subjected to a DSC measurement. The DSC measurement was carried out according to the ISO 11357 standard using a Mettler Toledo DSC 823.

The crystallisation temperature was then determined. The results are shown in Table 1 below.

TABLE 1
Crystallisation temperatures of mixtures of polymer particles
and different types of particulate carbon material.

Differential Scanning
Calorimetry (DSC),
20K/min
1st cooling
crystallisation temperature

| Composition/ | onset | extrapolated peak |
|---|---|---|
| details of components | [° C.] | [° C.] |
| PA 2201 + 0.09 wt. % | 150.71 | 145.27 |
| Monarch ® 570 | 151.02 | 145.43 |
| PA 2201 + 0.09 wt. % | 148.24 | 144.18 |
| Mogul L | 148.31 | 144.02 |
| PA 2201 + 0.09 wt. % | 143.77 | 139.59 |
| Spezialschwarz 4 | 144.03 | 139.85 |
| PA 2201 + 0.09 wt. % | 150.81 | 145.33 |
| Printex 200 | 150.53 | 145.08 |
| PA 2201 + 0.09 wt. % | 150.40 | 145.20 |
| Printex G | 150.12 | 144.89 |
| PA 2201 + 0.09 wt. % | 150.39 | 144.80 |
| FlammruB 101 | 150.34 | 144.77 |
| PA 2201 + 0.09 wt. % | 150.85 | 145.16 |
| Ensaco 150 P | 151.10 | 145.27 |
| PA 2201 + 0.09 wt. % | 150.67 | 145.21 |
| Timrex SFG 6 Graphite | 150.52 | 145.36 |
| PA 2201 + 0.09 wt. % | — | 146.73 |
| Printex XE-2B | — | 146.53 |
| PA 2201 + 0.09 wt. % | — | 139.26 |
| Arosperse 15 | — | 139.03 |

The results showed that the mixture containing gas black had the lowest crystallisation temperature of the test series. Since the mixtures differed only in the type of particulate carbon material, it follows that gas black resulted in the lowest increase in crystallisation temperature.

### Embodiment 2

Mixtures of polymer particles and different types of carbon black were prepared. The polymer particles were identical to the particles used in embodiment 1. Various commercial products containing industrial carbon black were used as carbon black types. These differed in particular in their particle size distribution.

The mixtures were homogeneously mixed and subjected to a DSC measurement as described in Example 1. The crystallisation temperature was then determined. The results are shown in Table 2 below.

TABLE 2
Crystallisation temperatures of mixtures of polymer
particles and different types of carbon black.

| | Differential Scanning | | | |
|---|---|---|---|---|
| | Calorimetry (DSC), | | | |
| | 10K/min | | | |
| | 1st cooling | | 2nd cooling | |
| | crystallisation | | crystallisation | |
| | temperature | | temperature | |
| | | extrapo- | | extrapo- |
| Composition/ | onset | lated peak | Onset | lated peak |
| details of components | [° C.] | [° C.] | [° C.] | [° C.] |
| PA 2200 | 148.87 | 144.43 | 147.24 | 142.51 |
| | 148.84 | 144.40 | 147.27 | 142.54 |
| PA 2200 + 0.09 wt. % | 154.54 | 150.56 | 153.04 | 149.27 |
| Monarch ® 570 | 154.29 | 150.52 | 152.88 | 149.23 |
| | 154.62 | 150.58 | 153.09 | 149.30 |
| PA 2200 + 0.09 wt. % | 148.90 | 145.30 | 147.38 | 143.64 |
| Spezialschwarz 4 | 148.89 | 145.27 | 147.42 | 143.64 |
| | 148.22 | 144.91 | 146.80 | 143.33 |
| | 148.30 | 145.04 | 146.82 | 143.41 |
| | 148.05 | 144.81 | 146.55 | 143.12 |
| | 148.10 | 144.89 | 146.60 | 143.18 |
| | 148.25 | 144.88 | 146.65 | 143.16 |
| | 148.11 | 144.88 | 146.80 | 143.20 |
| PA 2200 + 0.09 wt. % | 147.67 | 143.46 | — | — |
| Spezialschwarz 5 | 147.49 | 143.33 | — | — |
| | 147.62 | 143.50 | — | — |
| PA 2200 + 0.09 wt. % | 147.67 | 143.91 | — | — |
| Spezialschwarz 6 | 148.01 | 144.21 | — | — |
| | 147.99 | 144.16 | — | — |

The results show that the mixtures containing gas black had the lowest crystallisation temperature of the test series. This confirms for other gas black types that gas black leads to the lowest increase in crystallisation temperature.

### Embodiment 3

Selected mixtures of the above embodiments were used as building material in a selective laser sintering method.

In an experiment not described in detail here, it was confirmed that the building material according to the invention can in principle be used on a conventional laser sintering machine equipped with a CO₂ laser source, such as an EOS P 396 from EOS Electro Optical Systems, with the standard settings described by the manufacturer. In the present experiment, a light source comprising NIR laser diodes was used instead of a CO₂ laser. For further details on the hardware and suitable settings, reference is made to European patent application EP14824420.5, published as EP 3 079 912.

Subsequently, the distortion of the obtained components is determined. To quantify the distortion, a cuboid of dimensions 250 mm×6 mm×21 mm was built in the rear part of the construction space. The measure of manufacturing distortion (distortion during the manufacturing process) is the difference in the height of the cuboid between the measuring points at the edges and a measuring point in the middle (x=125 mm) of the cuboid in relation to the actual height of the cuboid in the middle as a percentage, wherein the height of the cuboid in the middle is usually greater than at the edges.

As a measure of the cooling distortion (distortion after the construction process not resulting in missing material in contrast to the manufacturing distortion), the curvature of the underside of the component is given at x=125 mm (centre of the component), wherein the shape of the curved underside is mathematically approximated with a parabola.

The following applies: f(x)=ax², with a=0 for a non-warped component.

The curvature of a graph is defined as κ(x)=((∂²f(x))/∂x²)/[(1+(∂f(x)/∂x)\hat{ }2)]\hat{ }(3/2).

Thus, at the centre of the component corresponding to the vertex of the parabola, κ(0)=2a.

The results are shown in Table 3 below.

TABLE 3
Distortion measurements on three-dimensional objects
made from mixtures of embodiments 1 and 2.

| | Distortion measurement on formed three- |
|---|---|
| Composition/ | dimensional objects: |
| details of components | Δ(h_{centre} − h_{left}) + Δ(h_{centre} − h_{right}) in [mm] |
| PA 2201 + 0.09 wt. % | 0.17 |
| Spezialschwarz 4 | |
| PA 2201 + 0.09 wt. % | 0.53 |
| Printex XE-2B | |
| PA 2201 + 0.09 wt. % | 0.56 |
| Monarch ® 570 | |

The evaluation of the distortion tests showed a significantly lower construction distortion for gas black than for the other types of carbon black tested. This confirms the assumption that the crystallisation temperature of industrial carbon black correlates with the distortion, i.e. the lower the crystallisation temperature, the lower the distortion.

### Embodiment Example 4

In this example, light microscopic images were taken of cooled melt of PA 12 (here PA 2201). These images are shown in FIGS. 2 and 3. FIG. 2 shows a cooled melt of PA 12 with large spherulites. FIG. 3 shows a cooled melt of a mixture of PA 12 and industrial carbon black using the example of Monarch® 570. This type of carbon black acts as a nucleating agent and leads to many small spherulites during crystallisation. Not shown is a cooled melt of a mixture of PA 12 and gas black using the example of Spezialschwarz 4. This type of black does not act as a nucleating agent and does not significantly change the size of the spherulites during crystallisation.

Further results of such experiments are shown in FIGS. 6 to 8.

### Embodiment 5

In this example, mixtures of polymer particles and different types of carbon black were prepared. The polymer particles were identical to those used in Embodiment 4. The carbon black types differed by the manufacturing method and therefore in their particle size distribution (PSD). As a further comparison, a mixture containing no carbon black type was investigated.

DSC iso-curves and conversions of the blends were recorded and shown as examples in FIG. 4. From these, tₚₑₐₖ [min] and t_{1/2} [min] and α [%] conversion were determined. tₚₑₐₖ refers to the time of the highest crystallisation rate. t_{1/2} refers to the time until half of the total crystallisation has been achieved. These values are presented in Table 4 below and in FIG. 5.

The different crystallisation kinetics of gas black (here: Spezialschwarz 4) become visible via the DSC iso-curves and the crystallisation conversion curves determined therefrom.

TABLE 4

| | Composition/ | | | | | | |
|---|---|---|---|---|---|---|---|
| Sample | details of components | T [° C.] | tₚₑₐₖ | t_{1/2} | T [° C.] | tₚₑₐₖ[min] | t_{1/2} |
| 236 | PA 2200 | 160 | 10.6 | 13.4 | 162 | 27.5 | 31.7 |
| 237 | PA 2200 + 0.09 wt. % | | 3.0 | 4.4 | | 8.3 | 11.2 |
| | Monarch ® 570 | | | | | | |
| 238 | PA 2200 + 0.09 wt. % | | — | — | | 30.0 | 33.1 |
| | Spezialschwarz 4 | | | | | | |
| 239 | PA 2200 + 0.09 wt. % | | 13.9 | 16.2 | | 32.8 | 36.9 |
| | Spezialschwarz 4 | | | | | | |
| 240 | PA 2200 + 0.09 wt. % | | 13.6 | 16.3 | | 39.3 | 39.9 |
| | Spezialschwarz 4 | | | | | | |
| 241 | PA 2200 + 0.09 wt. % | | 13.9 | 16.3 | | 39.2 | 41.4 |
| | Spezialschwarz 4 | | | | | | |
| 242 | PA 2202 black | | — | — | | 14.4 | 18.2 |
| 243 | PA 2200 + 0.09 wt. % | | — | — | | 7.3 | 10.2 |
| | Monarch ® 570 | | | | | | |
| 244 | PA 2200 + 0.09 wt. % | | — | — | | 7.5 | 10.0 |
| | Monarch ® 570 | | | | | | |
| 245 | PA 2200 + 0.09 wt. % | | 3.1 | 4.4 | | 7.5 | 11.0 |
| | Monarch ® 570 | | | | | | |
| 246 | PA 2200 + 0.09 wt. % | | 3.1 | 4.7 | | 7.1 | 9.9 |
| | Monarch ® 570 | | | | | | |
| 249 | PA 2200 + 0.09 wt. % | | 5.7 | 8.5 | | 14.6 | 17.8 |
| | Mogul L | | | | | | |
| 250 | PA 2200 + 0.09 wt. % | | 6.0 | 9.0 | | 16.3 | 20.1 |
| | Mogul L | | | | | | |

The invention claimed is:

1. A plastic powder for use as a building material for additively manufacturing a three-dimensional object by selectively solidifying the building material at the positions corresponding to the cross-section of the three-dimensional object in the respective layer,
wherein the plastic powder comprises a mixture of polymer-based particles and particles of a particulate additive, and
wherein the particulate additive is selected such that the crystallisation point of the mixture of the polymer-based particles and the particulate additive is substantially not increased compared to the crystallisation point of a mixture of the polymer-based particles without the particulate additive.

2. The plastic powder of claim 1,
wherein the particulate additive comprises a particulate carbon material.

3. The plastic powder according to claim 1,
wherein the particulate additive has an average primary particle diameter in the nm range.

4. The plastic powder according to claim 1,
wherein the particulate additive comprises a gas black which has an average primary particle diameter in the range of 15-70 nm.

5. The plastic powder according to claim 1,
wherein the particulate additive comprises a particulate NIR absorber.

6. The plastic powder according to claim 1,
which is in the form of a dry mixture of the polymer particles with the particulate additive.

7. The plastic powder according to claim 1,
wherein the weight percentage of the particulate additive to the total weight of polymer particles and particulate additive is from 0.01% to 5%.

8. The plastic powder according to claim 1,
wherein the polymer-based particles comprise as polymer material at least one polymer selected from at least one polyaryletherketone (PAEK), polyarylethersulfone (PAES), polyamide, polyester, polyether, polylactide, polyolefin, polystyrene, polyphenylene sulfide, polyvinylidene fluoride, polyphenylene oxide, polyimide, polyetherimide, polycarbonate, and/or at least one copolymer which includes at least one of the preceding polymers or their monomer units and/or at least one polymer blend comprising at least one of the mentioned polymers or copolymers.

9. A method of preparing a plastic powder according to claim 1 which is suitable for use in a method for the additive manufacturing of a three-dimensional object by selective solidification of a pulverulent building material at the positions corresponding to the cross-section of the three-dimensional object in the respective layer,
wherein the preparation comprises at least the following steps:
(i) providing the polymer-based particles,
(ii) providing the particles of particulate additive, and
till) dry mixing at least the polymer-based particles and the particles of particulate additive, wherein the particulate additive is selected such that the crystallisation point of the mixture of the polymer-based particles and the particulate additive is substantially not increased compared to the crystallisation point of a mixture of the polymer-based particles without the particulate additive.

10. A three-dimensional object which has been manufactured by selective solidification of a pulverulent building material based on polymer-based particles and a particulate additive at the positions corresponding to the cross-section of the three-dimensional object in the respective layer,
wherein the three-dimensional object has one or both of the following features:
(a) microscopically observable crystalline regions in the form of spherulites with a spherulite size of at least 20 μm,
(b) a distortion Δ(h_{centre}−h_{left})+Δ(h_{centre}−h_{right}) of at most 0.50 mm.

11. The three-dimensional object according to claim 10, having a distortion Δ(h_{centre}−h_{left})+Δ(h_{centre}−h_{right}) of ≤0.25 mm.

12. The three-dimensional object according to claim 10, made from a plastic powder for use as a building material for additive manufacture, wherein the plastic powder comprises a mixture of polymer-based particles and particles of a particulate additive, and wherein the particulate additive is selected such that the crystallisation point of the mixture of the polymer-based particles and the particulate additive is substantially not increased compared to the crystallisation point of a mixture of the polymer-based particles without the particulate additive.

13. A system for manufacturing three-dimensional objects by selectively solidifying a pulverulent building material at the positions corresponding to the cross-section of the three-dimensional object in the respective layer by exposure to a radiation, wherein the system comprises at least one radiation source, a process chamber which is formed as an open container with a container wall, a support arranged in the process chamber, wherein the process chamber and the support are movable relative to one another in a vertical direction, a storage container, and a recoater which is movable in a horizontal direction, wherein the storage container is at least partially filled with a plastic powder according to claim 1 as a building material.

14. The system according to claim 13,
wherein the radiation source is adapted to emit electromagnetic radiation specifically in a wavelength or wavelength range located in the NIR.

15. The system according to claim 13,
wherein the radiation source emits electromagnetic radiation in the range from 500 nm to 1500 nm.

16. The system according to claim 13, wherein the radiation source emits electromagnetic radiation at the wavelengths selected from the group consisting of (980±10) nm, (940±10) nm, (810±10) nm and (640±10) nm.

17. A method for manufacturing a three-dimensional object by selectively solidifying a pulverulent building material at the positions corresponding to the cross-section of the three-dimensional object in the respective layer by exposure to radiation, the method comprising at least the following steps:
providing a plastic powder for use as the building material, which plastic powder comprises a mixture of polymer-based particles and particles of a particulate additive, and
selectively solidifying the building material by exposure to electromagnetic radiation emitted by a radiation source,
wherein the crystallisation point of the mixture of the polymer-based particles and the particulate additive is substantially not increased compared to the crystallisation point of the polymer-based particles alone.

18. The method according to claim 17, wherein the radiation source is adapted to emit electromagnetic radiation specifically in a wavelength or wavelength range located in the NIR.

19. The method according to claim 17, wherein the radiation source emits electromagnetic radiation in the range from 500 nm to 1500 nm.

20. The method according to claim 17, wherein the radiation source emits electromagnetic radiation at the wavelengths selected from the group consisting of (980±10) nm, (940±10) nm, (810±10) nm and (640±10) nm.
